(19) United States
(12) Patent Application Publication
(10) Pub. No.: US 2015/0069187 A1
(43) Pub. Date: Mar. 12, 2015

(54) HOSTED INSTRUMENT RADIATOR SYSTEM

(71) Applicant: Lockheed Martin Corporation, Bethesda, MD (US)

(72) Inventors: Douglas V. MCKINNON, Princeton, NJ (US); David J. HENTOSH, Yardley, PA (US); Russell J. MOSSO, Robbinsville, NJ (US)

(21) Appl. No.: 14/463,538

(22) Filed: Aug. 19, 2014

Related U.S. Application Data
(60) Provisional application No. 61/875,578, filed on Sep. 9, 2013.

(51) Int. Cl. B64G 1/50; B64G 1/10

(52) U.S. Cl. CPC B64G 1/50; B64G 1/1014; B64G 1/503; B64G 1/506
USPC 244/171.8

(57) ABSTRACT

An instrument mounting system for a geosynchronous host satellite provides independent heat rejection capability for a hosted instrument. The system may include an instrument mounting structure that is thermally coupled to a radiator component via heat pipes that may include one or both of rigid and flexible elements. In some embodiments, the system is mounted on the hosting satellite so as to provide satellite components and the hosted instrument with a clear field of view while rejecting heat in one or both of the north and south directions. The system may also provide structural support for components of one or both of the hosted instrument or the hosting satellite.

### CROSS-REFERENCE TO RELATED APPLICATIONS

This application claims the priority benefit of U.S. Patent Application No. 61/875,578, filed on Sep. 9, 2013, the entirety of which is incorporated herein by reference.

### STATEMENT REGARDING FEDERALLY SPONSORED RESEARCH OR DEVELOPMENT

Not applicable.

### FIELD

The present disclosure generally relates to an instrument mounting system for a satellite, and in particular to, for example, without limitation, a hosted instrument radiator system.

### BACKGROUND

Accommodation of precision instruments as hosted payloads on commercial or communications satellites promises to dramatically reduce the costs associated with deploying such instrument based systems. Precision instruments may require different accommodation resources than those generally available on commercial satellites. Commercial satellite customers are reluctant to offer their satellites as instrument hosts if doing so would add significant cost, risk, or schedule impact.

The description provided in the background section, including without limitation, any problems, features, solutions or information, should not be assumed to be prior art merely because it is mentioned in or associated with the background section. The background section may include information that describes one or more aspects of the subject technology.

### SUMMARY

The description in this summary section may provide some illustrative examples of the disclosure. This section is not intended to be a broad overview or to identify essential elements of the disclosure.

In accordance with an aspect of some embodiments of the inventions disclosed herein is the realization that the rejection of waste thermal energy from a hosted instrument is one of the most challenging problems associated with hosting a precision instrument. Waste heat must be removed from the instrument using a thermal sink operating at a temperature well below those typically available on commercial satellites, often below 20° C., and a separate thermal energy removal system for the hosted instrument must often be added to the host satellite. These auxiliary radiator systems are typically expensive and consume large amounts of valuable physical space on the satellite.

Additionally, an aspect of some embodiments is the realization that some hosted instruments are very sensitive to torques generated by satellite thermal gradients and material coefficient of thermal expansion (CTE) effects. It is sometimes necessary to minimize the mechanical coupling between spacecraft-provided waste heat radiators and the hosted payload.

Therefore, according to some embodiments, an instrument mounting system is provided that can comprise a thermal radiator component to provide independent heat rejection capability for an instrument that is hosted on a geosynchronous satellite.

The system can comprise an instrument mounting surface. In some embodiments, the instrument mounting surface can be coupled to the radiator component. The instrument mounting surface can be thermally coupled to the radiator component, for example, via heat pipes that may include one or both of rigid or flexible elements.

In some embodiments, the system can be mounted on the hosting satellite so as to provide the hosted instrument with a clear field of view of the Earth while rejecting heat in one or more directions, such as one or both of the north and south directions.

The system may also provide structural support for elements or components of one or both of the hosted instrument or the hosting satellite.

The system may be integrated with the instrument prior to installation of the instrument on the hosting satellite, thereby allowing the system to be tested and integration issues resolved without impact on the timelines of the hosting satellite or the launch vehicle.

The system may provide higher performance thermal control than that available on the hosting satellite while avoiding the need to modify the host satellite to accommodate the instrument. This may provide a greater number of possible hosting satellites.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIGS. 1-2 depict a commercially hosted infrared payload mounted on a commercial GEO satellite.

FIGS. 3-4 depict typical Earth-deck mounting constraints imposed on a hosted instrument.

FIG. 5 depicts a satellite with an instrument mounting assembly in a deployed configuration, according to some embodiments.

FIGS. 6A-6D depict top, front, side, and isometric views of a typical instrument to be hosted on a satellite.

FIG. 7A shows an enlarged view of the mounting assembly of FIG. 5 in the stowed configuration, according to some embodiments.

FIG. 7B depicts the mounting assembly of FIG. 7A in a deployed configuration, according to some embodiments.

FIG. 8A depicts another exemplary radiator assembly, according to some embodiments.

FIG. 8B depicts an instrument mounted on the instrument mounting panel of the mounting assembly of FIG. 8A, according to some embodiments.

FIG. 9A is an enlarged side view of the mounting assembly of FIG. 8A, according to some embodiments.

FIG. 9B is a further enlargement of the heat pipe at the corner of the mounting assembly of FIG. 9A, according to some embodiments.

FIGS. 10A-10C depict an example instrument attached to an exemplary mounting assembly and mounted on a host satellite within a typical launch vehicle fairing, according to some embodiments.

### DETAILED DESCRIPTION

The present disclosure generally relates to a radiator system provided for a secondary electronic package, such as a scientific instrument or payload, hosted on a multi-function satellite, such as a communication or commercial satellite.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

In accordance with some embodiments disclosed herein is the realization that host commercial satellites present an opportunity for hosting one or more secondary instruments, sensors, or payloads. The ability to host an additional payload on a satellite can generate additional revenue for the host satellite and provide a budget-efficient opportunity for another party to have a payload carried by the host satellite without incurring the full cost the host satellite. Accordingly, in some embodiments, payloads can be placed on existing satellites and thereby enable a party to enjoy substantial cost savings. These opportunities can stimulate exciting new ventures and give companies the ability to pursue previously unreachable goals.

However, an aspect of at least some embodiments disclosed herein is the realization that the ability to place an additional payload on a host satellite creates substantial risk for the host satellite. In order to take advantage of such opportunities, the payload and the system used to incorporate the payload must meet strict requirements associated with the host satellite. In particular, some embodiments disclosed herein recognize the requirement that a host satellite be configured in an efficient, space-saving configuration that ensures that all components of the satellite and accompanying payload can function properly and reliably. Such satellites are built to strict specifications that are demanding and sensitive.

Therefore, an aspect of at least some embodiments disclosed herein is the realization that in order to enable a satellite to host an additional payload, the payload must provide mere noise or insignificant effects to the satellite and instrumentation thereof. The noise or effects shall be considered insignificant if the satellite and its instrumentation are able to perform their intended function.

In making this possible, some embodiments minimize the thermal distortion or vibration of the system such that the additional payload can be accommodated on the host satellite with minimal adverse effects. The additional payload may be sensitive to thermal-distortion-induced torques originating from the host satellite or the hosted payload thermal radiator system (provided by the host satellite). Thus, some embodiments advantageously avoid the need for thermal distortion reducing modifications to the host satellite and therefore reduce the impact of any necessary accommodations, thereby increasing the likelihood that a given host satellite qualifies or could be used with some embodiment disclosed herein. Indeed, as noted above, a candidate hosted instrument should be accommodated in the most simplistic and non-impactful way possible in order to maximize its chances of finding a host.

Some embodiments of the disclosed system provide a thermal control capability that is otherwise not available in a hosting satellite. Some embodiments of the disclosed system may also provide structural support for instrument elements, for example a deployable antenna or non-deployable sunshade. Some embodiments allow the system to integrate the instrument with a thermal control system and/or a structural support in advance of mounting the system on the hosting satellite. The instrument and system may be integrated and tested prior to installation on the hosting satellite, possibly reducing one or more of the time, schedule, risk, or cost elements of the integrated satellite program. Such advantages can decouple the mounting and assembly activities from the timeline of the hosting satellite and launch vehicle preparation, thereby taking the instrument off of a critical path schedule. This may also advantageously reduce the risk and cost of integration and timeline disruption, as problems with the instrument can be worked out without delay of the entire program.

Further, some embodiments of the disclosed radiator system can provide a self-contained thermal control system for an instrument to be hosted on a GEO satellite. The system can comprise a radiator component that enables the system to have one or more fields of view (“FOVs”) directed toward the Earth and/or a select lateral direction, for example north, south, east, or west, and reject heat, for example, to one or both of the northern space or southern space.

In current satellite configurations, satellites are most efficient if the instrumentation and existing equipment occupies the entirety of the available space; the satellite should be made as compact as possible while being as large as necessary. Accordingly, the prior art has not attempted to create an available space on a host satellite for a secondary instrument or payload, especially for a large-scale instrument or payload or in situations in which the host satellite requires large components.

However, in accordance with some embodiments disclosed herein, an instrument mounting system can enable large-scale payloads to be hosted on host satellites. For example, the size of the payload or instrument that can be hosted on the satellite can be of an instrument class that is large-scale, or much larger compared to the instrumentation of the satellite itself

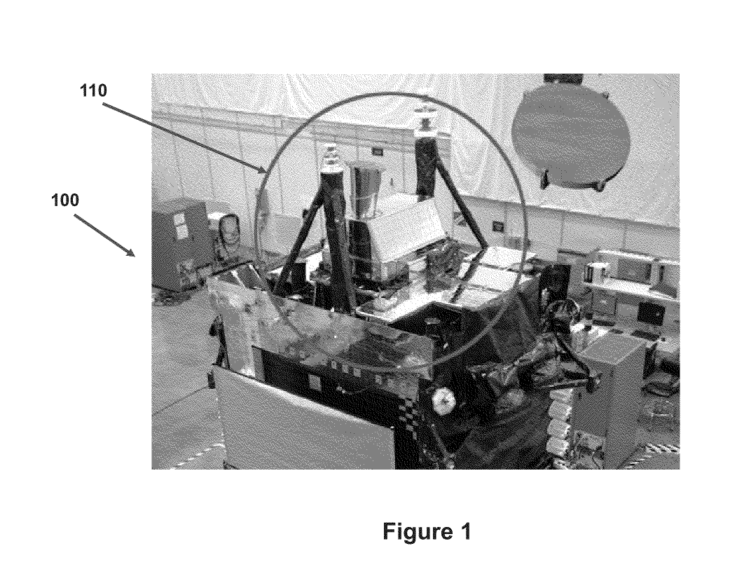

Referring to FIGS. 1-2, a host satellite 100 can be configured to support or carry a small-scale hosted payload 110. The satellite 100 and hosted payload 110 illustrated in FIG. 1 demonstrates that there have been no known instances of large-scale hosted precision instruments or payloads. As used herein, “large-scale” payloads can refer to payloads that are at least about, 0.7 m³, 0.8 m³, 0.9 m³, 1 m³, 1.1 m³, 1.2 m³, or larger in size. No such large-scale hosted payload has been used on prior satellites or other implementations thereof, whether combined with large antenna or large thermal radiator systems.

Further, none of the prior systems, such as that illustrated in FIG. 2, included a large-scale payload in combination with any substantial or large antennae or radiator systems. Thus, as illustrated in FIGS. 1-2, prior systems have not been capable of supporting large-scale payloads, especially when the host satellite 100 required large-scale antennae, control modules, radiators, or other electronics.

In accordance with some embodiments disclosed herein, a system is provided that can enable a host satellite to support a larger payload or instrument simultaneously with large host satellite payload antennas or equipment. Further, some embodiments of the system can be capable of isolating radiator panel thermal distortion torques or translations from the payload or instrument. For example, some embodiments can use, a deflectable heating system, such as a flexible heat pipe system. Additionally, some embodiments can provide a system that is uniquely configured to accommodate a large-scale payload or instrument by utilizing unique radiator panel shapes that are configured to maximize capacity within launch vehicle fairing constraints. Furthermore, some embodiments of the system can enable the integration of a high-value payload or instrument with significantly higher size, mass, power, or thermal resource requirements, onto a typical commercial geosynchronous communications satellite.

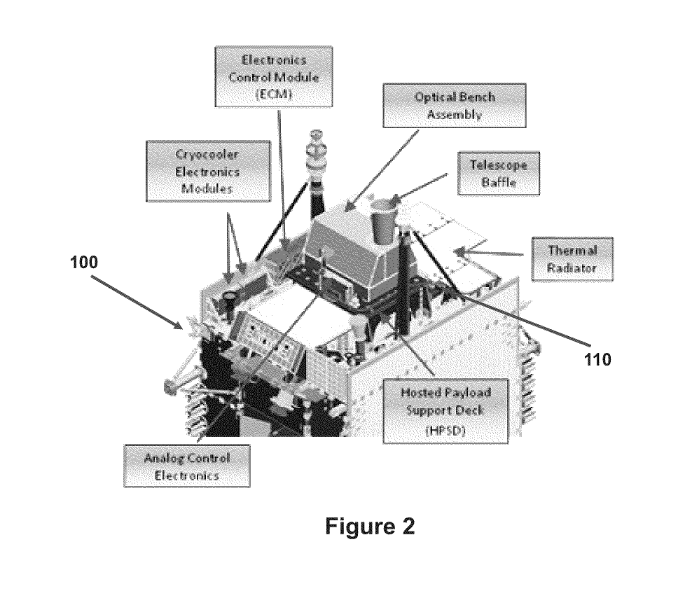

Referring now to FIGS. 3-4, a satellite 120 is shown that comprises a deck area 122 that is substantially limited in size and typically used for host mission antennas and spacecraft sensors. As such, the satellite 120 has little to no space for accommodating any additional payload or instrument thereon. FIGS. 4 is a top view of the satellite 120.

As shown in FIGS. 3-4, the satellite 120 can comprise spacecraft primary thermal radiators 130 that have north and south faces, primary mission communication antenna feeds 132, one or more primary mission communications antenna reflectors 134 that need a clear view to earth, satellite earth sensors 136 that need a clear view to earth, primary mission communication antennas 138 that also need a clear view to earth, and other related equipment. While excess spacecraft thermal energy is radiated to space in the north and south directions 140, 142, other equipment of the satellite 120 requires a clear view to the earth. Traditionally, such constraints made it impossible to host any large-scale payloads or instruments.

However, in accordance with some embodiments disclosed herein, a system is provided by which an innovative solution to this conflict between the host satellite and the hosted payload is resolved. In particular, some embodiments allow the field of view, area, and thermal energy rejection requirements to the resolved such that a host satellite can carry a large-scale hosted payloads while ensuring that all of the host equipment and the payload itself are capable of operating within the field of view, area, and thermal energy rejection requirements.

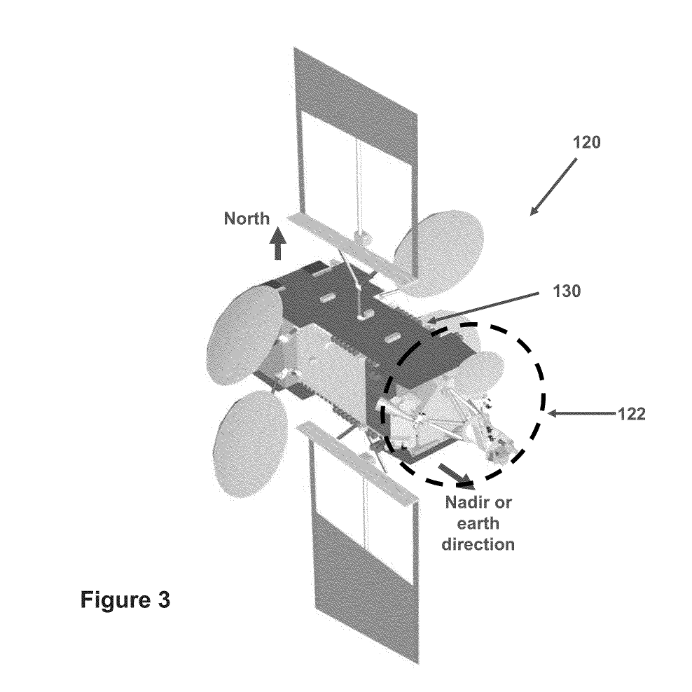

FIG. 5 illustrates an embodiment of a system 200 that can be used with a satellite 202 in order to accommodate a large-scale payload 300 along with various host satellite components 210.

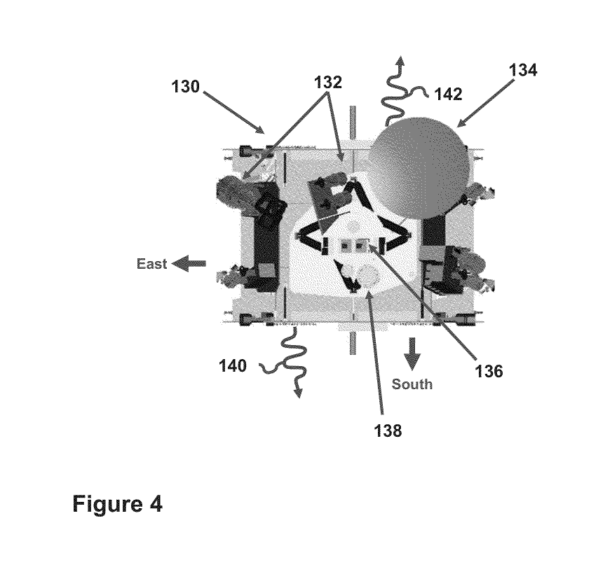

As illustrated in FIGS. 6A-6D, the payload 300 can comprise a precision instrument that has significant mounting, thermal, or field-of-view constraints that must be accommodated by the host satellite 202. The hosted payload 300 can comprise two separate thermal dissipation rejection systems. A first thermal dissipation rejection system of the payload 300 can comprise a north or south facing self-contained instrument thermal radiator 302 to reject heat directly to space, as shown in FIGS. 6A-6B and 6D. The thermal radiator 302, when the payload 300 is positioned on the host satellite 202, would generally require that the thermal radiator 302 have a mostly clear field of view to space. Such a clear field of view would therefore allow excess thermal energy to be radiated directly to space from the radiator 302. The second thermal dissipation rejection system can eliminate heat through a surface 304 and a mounting panel or conductive interface 306, as shown in FIGS. 6A and 6C-6D. The payload can also comprise an anti-Earth or Zenith direction surface 304 through which a portion of the payload's excess thermal energy can be dissipated, such as by conduction, to a host spacecraft. In some embodiments, the host spacecraft can receive conducted heat if the temperature at the interface between the host spacecraft or satellite 202 and the payload 300 is less than about 20° C. The conductive interface 306, due to instrument electronics sensitivities, may preferably run at temperatures (at or below 20° C.), which are well below those used on the host satellite (up to 71° C. or even higher).

In addition, the conductive interface 306 can provide a mounting structure that enables the interface 306 to be coupled to the Zenith direction surface 304 of the payload 300. The mounting structure of the conductive interface 306 can be configured to enable the payload 300 to be mechanically mounted or anchored onto the host satellite 202.

Furthermore, the payload 300 can also comprise an instrument aperture 310. The instrument aperture can allow the payload to perform a desired function and will require that the instrument aperture 310 have a clear view to the earth.

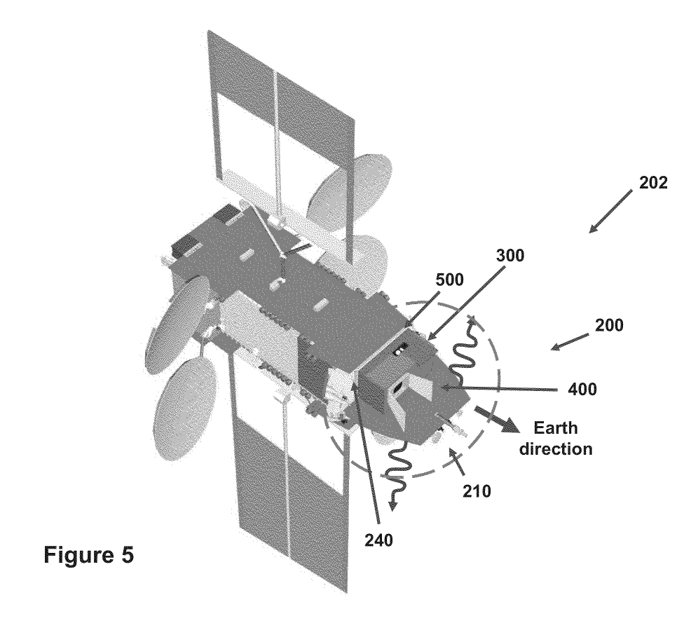

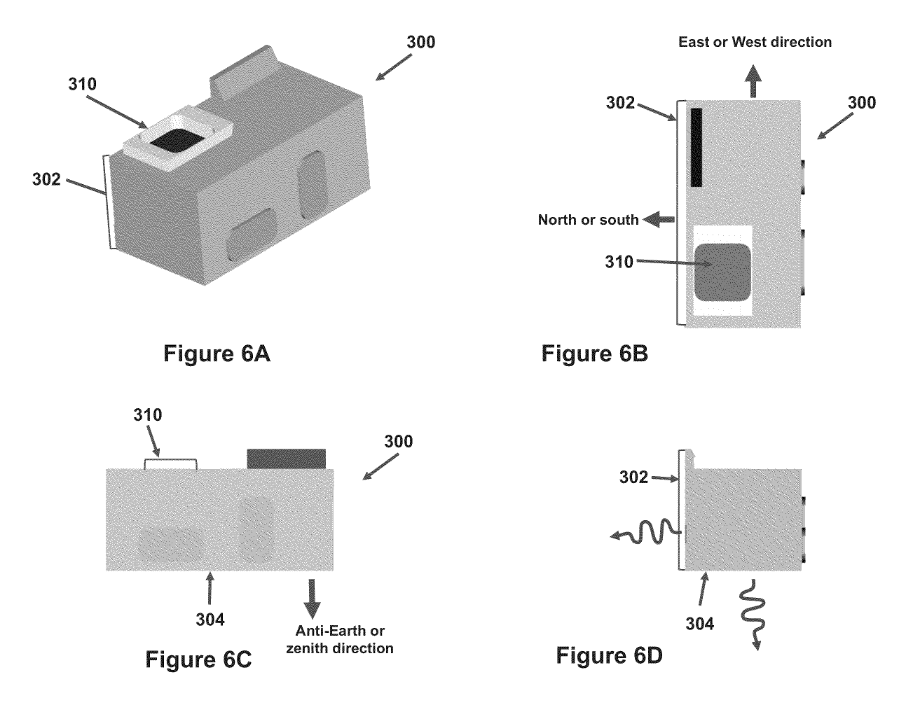

Referring to FIGS. 5 and 7A-7B, in some embodiments, the system 200 can comprise a thermal radiator 400 that can be configured to carry or support components of the host satellite 202, such as antenna, electronics, optical, or other components of the host satellite 202. In some embodiments, the radiator 400 can enable one or more of the components 210 of the host satellite 202 to be structurally mounted onto the satellite 202 and allow these components to have satisfied the required field of view, area, and thermal heat rejection requirements.

An embodiment of a radiator component of the system is shown in FIGS. 5 and 7A-9B. As illustrated therein, the radiator 400 can comprise a first or host instrument side 410 along which the host components 210 can be mounted or supported and a second or hosted instrument side 412. As demonstrated, the field of view, area, and thermal heat rejection requirements can be satisfied by positioning the host equipment or components 210 along the first side 410 of the radiator 400. Such requirements can be met and satisfied by positioning these components 210 along the first side 410 of the radiator 400 while positioning the host instrument or payload 300 along the second side 412 of the radiator 400.

In some embodiments, the hosting satellite 202 may utilize the structure of the radiator 400 to mount elements, for example antenna feed horns or secondary antennae. In some embodiments, the structure of the radiator 400 may provide separate mounting surfaces, e.g, an Earth deck, into a first portion utilized by the hosting satellite and a second portion utilized by the hosted instrument.

As noted above, the host components 210 can comprise host satellite secondary antennas host satellite secondary antennas can comprise, for example, host satellite secondary antennas 220, host satellite antenna feed horns 222, and a host satellite antenna reflector 224. In addition, the system 200 can also be configured such that the radiator 400 comprises a reflector deployment mechanism 226 that allows the reflector 224 to rotate from a stowed position (illustrated in FIG. 7A) to a deployed position (illustrated in FIG. 7B). In such an embodiment, the system 200 can comprise one or more antenna reflector launch configuration tie-down points 230 that allow the reflector 224 to be maintained in the stowed or launch configuration until released and deployed. The embodiment illustrated in FIGS. 7A-7B illustrates an example of various host equipment configurations and needs that can be satisfied in accordance with some embodiments of the system 200.

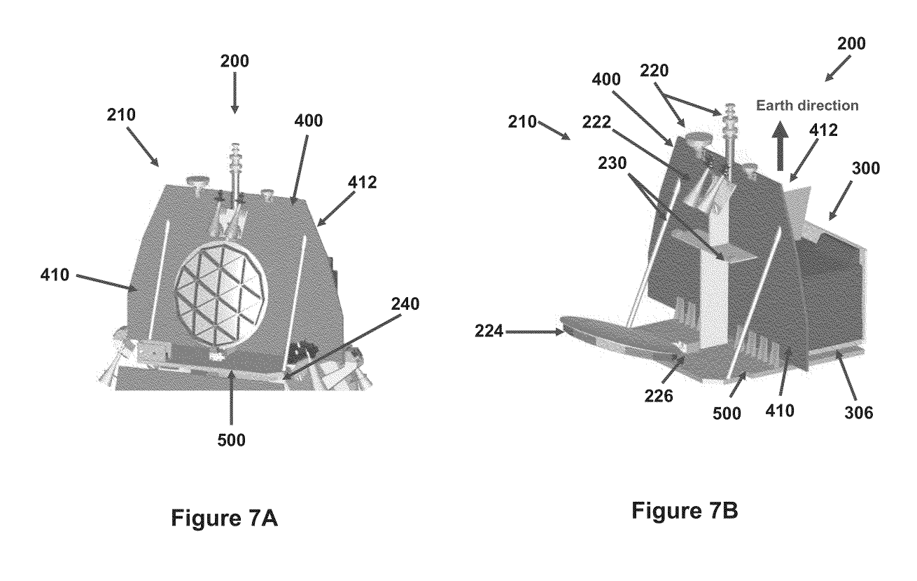

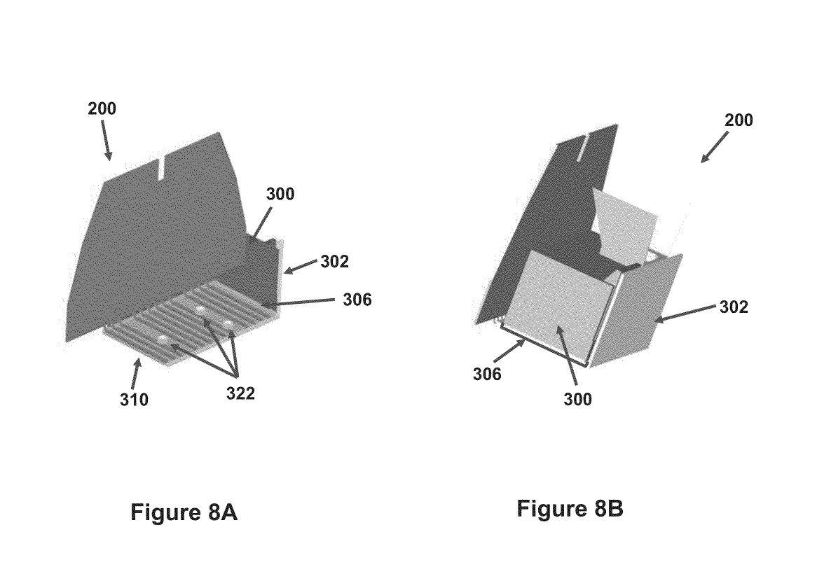

As also illustrated in FIGS. 7A-7B, the system can comprise a base structure 500 that can be coupled to the radiator 400 such that the radiator 400 extends from the base structure at an angle generally transverse relative to the base structure 500. For example, in some embodiments, the radiator 400 can be oriented substantially perpendicular relative to the base structure 500. As shown in FIG. 5, the base structure 500 can be coupled to a base panel or nadir deck 240 of the host satellite 202. The base structure 500 can allow the system 200 to be coupled to the host satellite 202. The base structure 500 can comprise a face or panel, as well as internal structural members. The base structure 500 can be oriented parallel relative to the nadir deck 240 when coupled to the host satellite. Further, some embodiments may be implemented in which the system does not comprise a base structure 500. Instead, the system 200, as shown in FIGS. 8A-8B with the hosted payload attached, would attach to the spacecraft's nadir deck 240 directly without the use of a base structure 500.

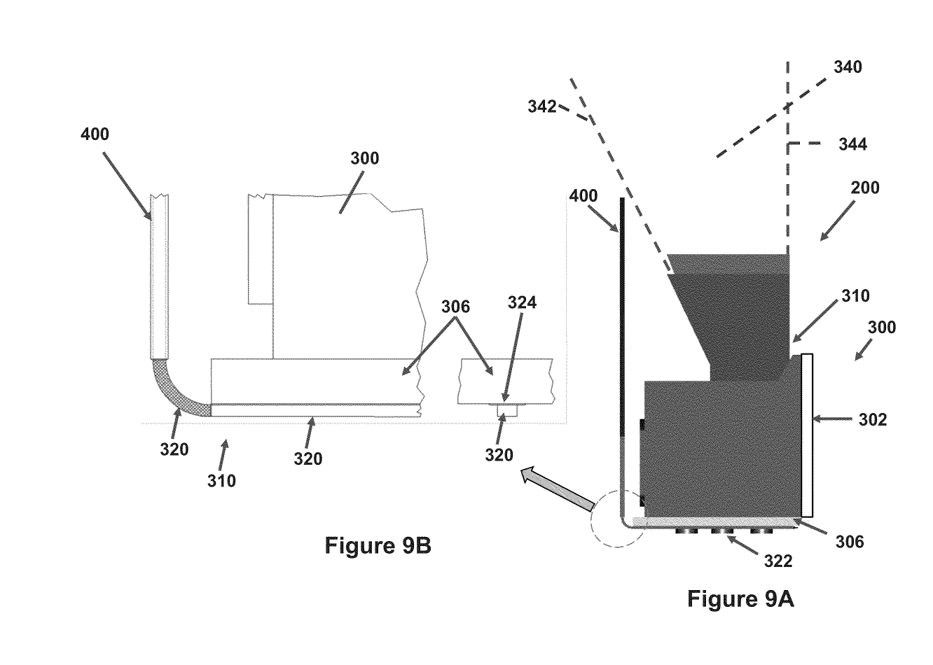

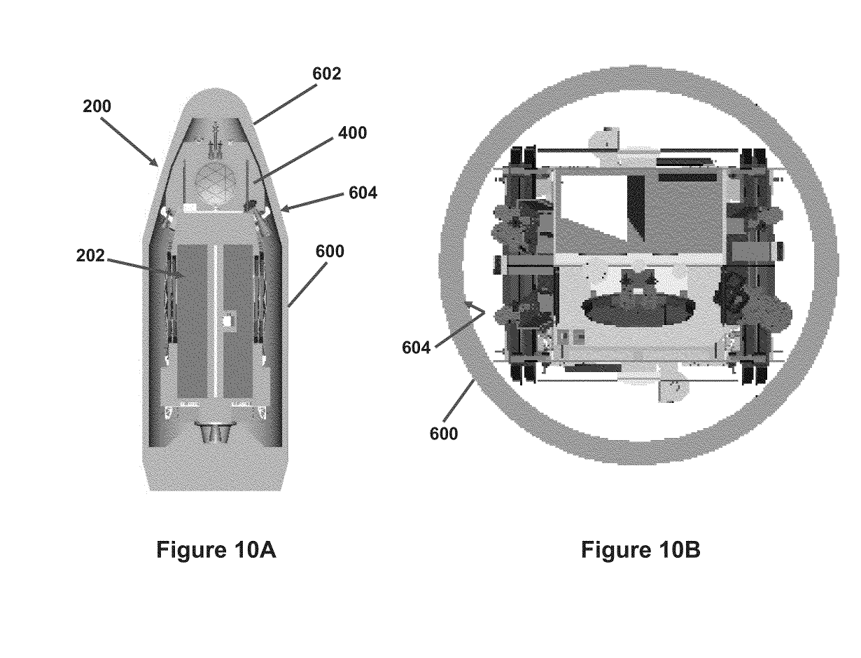

The components 210 can generally be very sensitive to anything in their field of view. In particular, the components 210 generally require a clear field of view to the earth. Referring briefly to FIG. 9B, which illustrates a side view of a portion of the system 200, the hosted payloads 300 can have a required field of view 340 that extends away from the mounting structure 306 of the system 200. The field of view 340 can be accommodated by the profile of the radiator 400. For example, a left edge 342 of the field of view can extend transversely relative to the radiator 400 without intersecting the radiator 400, as shown in FIG. 9B. Further, a right edge 344 of the field of view 340 can extend generally parallel relative to the radiator 400 in a path that does not intersect with the radiator 400 or a plane of the radiator 400. Accordingly, the radiator 400 can be configured such that its profile permits a free field of view of the instrument aperture 310 of the payload 300. Additionally, the host components 210 can also benefit from the profile of the radiator 400. The profile of the radiator 400 can be configured such that it does not interfere with the field of view of the host components 210. For example, the field of view of the reflector 224, similar to the field of view 340 of the payloads 300 can extend above the radiator 400 without interference from the radiator 400. The other components, such as the horns and antennas of the equipment 210 can similarly be free of any interference with the profile of the radiator 400.

Referring still to FIGS. 7A-7B, the radiator 400 can be thermally independent of the components 210 and/or the satellite 202 and run at lower temperatures to suit the needs of the hosted payload 300. The radiator 400 can be mechanically independent from the payload 300. The radiator 400 can be thermally coupled to the base of the payload 300 (through the conductive interface 306). Therefore, the conductive interface 306 can run at nominally the same temperature as the radiator 400 (e.g., heat pipes can nominally isothermalize along their length). The temperature that the conductive interface 306 and the radiator 400 run at can be cooler (e.g., sometimes about 20° C.) than the satellite itself (e.g., sometimes about 71° C.), but warmer than the thermal radiator 302. Therefore, in some embodiments, the radiator 400 can be thermally independent from the satellite 202, but not the conductive interface 304. Further, in some embodiments, while the host payload components 210 may not produce significant thermal dissipations, the radiator 400 could and may need to radiate any thermal dissipation produced by components 210. In accordance with an aspect of at least some embodiments disclosed herein, the radiator 400 can therefore serve a dual use by radiating excess heat while also providing a structure onto which the components 210 can be mechanically mounted. The components 210 can be mounted to the radiator 400 and therefore be mechanically and thermally coupled to the radiator 400. However, some of the components 210 can be dissipative and experience temperatures well above those seen on the radiator 400 (e.g, transmit feed horn(s) can be coupled to the radiator 400 in locations via a path with relatively high thermal impedance).

As discussed above with respect to FIGS. 7A-7B, the mounting structure or interface 306, due to instrument electronics sensitivities, may preferably run at temperatures (at or below 20° C.), which may be well below those used on the host satellite (up to 71° C. or even higher). The payload 300 may run at a lower temperature than an operating temperature of the equipment 210 of the host satellite 202. Thus, the radiator 400 can provide the system 200 with a space efficiency advantage, allowing the host equipment or components 210 to be mounted thereon instead of an additional structure independent of the hosted payload thermal radiator accommodation system.

FIGS. 5 and 7B depict an exemplary instrument mounting assembly in a deployed configuration, according to some embodiments. This example configuration provides an integrated thermal radiator and antenna mounting structure. The radiator 400 can provide structural mounting of antenna components, which conserves valuable satellite deck mounting space, and is compatible with both the host and instrument FOV constraints. As discussed further herein, heat removal may be accomplished using simple constant conductance heat pipes, if mechanical decoupling is not required. If minimization of mechanical coupling is desired, for example, to reduce to torque on instrument due to radiator and spacecraft thermal distortion, flexible heat pipes may be employed.

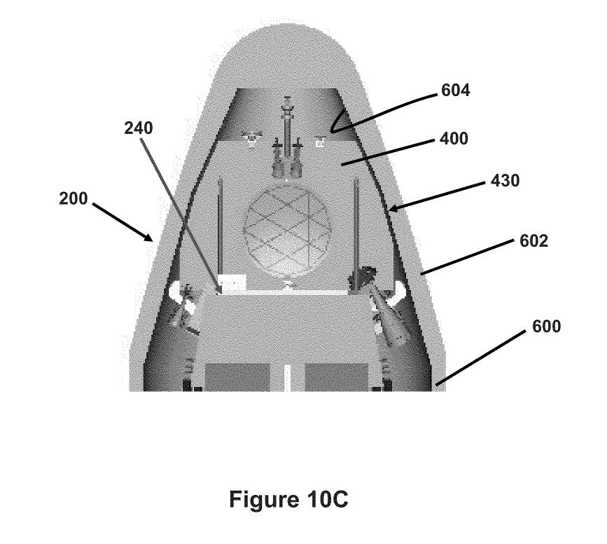

FIGS. 10A-10C depict an example instrument attached to an exemplary mounting assembly and mounted on a host satellite within a typical launch vehicle fairing, according to some embodiments.

In accordance with some embodiments, the radiator 400 can have a design that is specifically configured such that the radiator 400 maximizes available space within the launch envelope. For example, FIGS. 10A-10C illustrate examples of a typical commercial satellite with a hosted instrument that is stowed for launch. FIG. 10A illustrates a launch vehicle 600 having a fairing 602 that defines a large envelope 604 within the fairing 602. In these figures, the system 200 is illustrated mounted onto a host satellite 202. The system 200 comprises the radiator 400, which can comprise a perimeter profile 430 that can closely approximate an internal contour or shape of the launch envelope 604. The launch envelope 604 defines a volumetric constraint into which the system 200, including host components 210 and the payload 300, must be fitted.

An aspect of at least some embodiments disclosed herein is the realization that although prior satellites must be fitted into the launch envelopes into which they are placed, some embodiments disclosed herein are configured such that the system 200 closely approximates the launch envelope in order to maximize radiator size while accommodating host equipment and a secondary instrument or payload. For example, some embodiments comprise a radiator 400 that is uniquely positioned within an upper portion 602 of the fairing. Further, in some embodiments, as discussed herein, the host components 210, the radiator 400, and the hosted payloads 300 can approximate the internal shape of the upper portion of the launch vehicle fairing 600. Prior systems provides no related designs or solutions, which is consistent with Applicant's understanding that the problem being solved in some embodiments is a new problem and the solutions presented herein have been unnecessary to this point and are only now being solved using embodiments of the inventions disclosed herein.

In accordance with some embodiments disclosed herein, the radiator 400 can comprise a shape that is specifically contoured to typical launch vehicle fairing constraints and designed to maximize the dedicated instrument thermal radiator size and capacity of the radiator 400. The radiator 400 can comprise one of a variety of unique profiles based on the required launch vehicle fairing compatibility.

For example, some embodiments provide a system 200 that includes a thermal radiator 400 that has a tapered or tapering perimeter 430 that can fit within a launch envelope 604 such that the perimeter 430 closely approximates an inner contour or surface of the launch envelope 604.

Referring now to FIGS. 8A-9B, the system 200 can be configured to provide a conductive heat removal capability, according to some embodiments.

FIG. 8A depicts an exemplary radiator assembly, according to some embodiments. A planar instrument mounting surface is provided that, in some embodiments, may also provide attachment features to secure the mounting assembly to the host satellite. In some embodiments, the instrument mounting surface may be perpendicular to an Earth-pointing axis. A planar thermal radiator is provided at a right angle to the instrument mounting surface. In some embodiments, the plane of the radiator may be perpendicular to a north-south axis such that heat may be radiated from the radiator in one or both of a north and a south direction.

The instrument mounting surface and the radiator can be thermally connected by one or more heat pipes. A portion of the one or more heat pipes may be embedded in the radiator or, in some embodiments, thermally coupled to the surface of the radiator. In some embodiments, a second portion of the one or more heat pipes may be flanged and attached to instrument mounting plate using mechanical fasteners and thermal adhesive or filler material. In some embodiments, the instrument end of the heat pipes may directly embedded in an instrument mounting panel. In some embodiments the right angles in the heat pipes are typical rigid heat pipe if thermal distortion isolation is not a concern. In some embodiments the right angles in the heat pipes may be a flexible heat pipe. In some embodiments, a “loop” heat pipe may be used for a portion of the heat pipes.

FIG. 8B depicts an instrument mounted on the instrument mounting panel of the mounting assembly of FIG. 8A, according to some embodiments. In some embodiments, the radiator system provides a clear view of Earth, i.e. along the nadir or Earth pointing axis, while rejecting heat in one or both of north and south directions.

As shown in FIGS. 8A-9B, the system 200 can provide heat removal using thermal radiator components. For example, the heat removal can be accomplished using conductive heat removal, in some embodiments.

Referring to FIGS. 8A-8B, the system 200 comprises the mounting structure 306 that can be configured to remove or facilitate removal of heat from the payload 300. For example, the waste heat coming out of the payload 300 can move through the system in one or more pathways.

For example, as noted above with regard to FIGS. 6A-6D, a first pathway for heat removal can be through the thermal radiator 302. The thermal radiator 302 can comprise a very low temperature radiator that can provide removal of waste heat from the most sensitive elements or components of the payload 300. These elements of the payload 300 can be running at a temperature of about 77 Kelvin, which therefore requires very low temperature independent heat removal.

A second pathway can be provided for heat removal from components of the payload 300 out of baseplate of instrument and at a cooler temp than satellite. Such components can include electronics and computer support equipment, which can be mechanically isolated from the radiator 400 and require or use a radiator that operates at a lower temperature than the host spacecraft 202. The removal of the heat through the second pathway can be accomplished using some embodiments disclosed herein.

Further, as illustrated in FIGS. 8A-8B, the second pathway for heat removal can include the mounting structure 306. The mounting structure 306 can be coupled to the zenith direction face of the payload 300. In accordance with some embodiments, the mounting structure 306 can include one or more heat pipes. For example, the mounting structure 306 can comprise a honeycomb structure with heat pipes. In some embodiments, the heat pipes can be embedded into one or more structures of the system 200. In another embodiment, the mounting structure 306 may be a solid, or other non-honeycomb plate, and the heat pipes would be attached directly to the bottom of the plate. The heat pipes may have flanges 324 (visible in FIG. 9B in the end view). The flanges 324 can be attached to the mounting structure 306 with mechanical fasteners and/or thermally conductive filler/adhesive.

Referring to FIG. 9B, some embodiments can comprise the mounting structure 306 and a heat pipe assembly 310 that can be coupled to or embedded in the mounting structure 306. Further, as illustrated in FIG. 9B, the heat pipe assembly 310 can be coupled to or embedded in the mounting structure 306 and/or in the radiator 400. In some embodiments, the heat pipe assembly 310 can be attached to an instrument mounting structure 306 interposed between the mounting structure 306 and the nadir deck 240 or 500 of the satellite 202.

The heat pipe assembly 310 can comprise heat pipes that can be positioned about at least one surface of the payload 300 to provide conductive heat removal from the at least one surface of the payload 300. Further, the heat pipe assembly 310 can comprise one or more constant conductance heat pipes.

In some embodiments, the heat pipe assembly 310 (which extends along the mounting structure 306) can be secured to the payload 300 using one or more mechanical fasteners. Further, the interface between the heat pipe assembly 310, the instrument mounting structure 306, and the payload 300 can also be filled with thermal adhesive or other filler material.

The heat pipe assembly 310 can be coupled to the mounting structure 306 and/or the radiator 400, which can extend transversely relative to each other. An individual heat pipe 320 is shown in the side view of FIG. 9B. The heat pipe assembly 310 can comprise between four to 20 individual heat pipes, and in some embodiments, ten heat pipes. Each pipe can, as seen in FIG. 8A, have a L-shaped body that runs along a bottom of mounting structure 306 (see e.g., FIG. 9B) and make a 90 degree bend (see e.g., FIG. 9B), and run in the nadir direction internal to radiator panel 400. Further, the heat pipe assembly 310 can comprise a standard rigid constant conductance heat pipe, a flexible pipe, or a loop heat pipe system. Thus, as an alternative to a flanged heat pipe design that is mechanically fastened to the radiator panel, the heat pipe assembly 310 can be configured such that one or more pipes of the assembly 310 bend at a right angle using a typical rigid heat pipe (if thermal distortion isolation is not a concern), a flexible heat pipe (if thermal distortion isolation is a concern, and to facilitate assembly and testing of the system 200) or a loop heat pipe system.

Accordingly, some embodiments can provide heat removal using a two-sided instrument thermal radiator 400 and an embedded heat pipe system 310.

Additionally, the mounting structure 306 can facilitate heat removal and provide a means for mechanically interconnecting the payload 300 with the nadir deck 240 of the satellite.

In addition, some embodiments can be configured such that the heat pipe assembly 310 is flexible. A flexible heat pipe assembly can provide a compliant interface between the heat removal system and components supported on the radiator 400, and/or the mounting structure 306. In such embodiments, distortions induced by differential heating of the components of the system 200 can be avoided. For example, expanding and contracting movements of the heat pipe assembly 310 can cause torques or forces to which the instruments of the payload 300 may be sensitive. Thus, in some embodiments, a flexible heat pipe assembly can be used to alleviate torsion, tension, or other forces that could otherwise affect elements of the payload 300.

Referring again to FIGS. 8A and 9B, the system can comprise one or more mounts 322 coupled to the mounting structure 306 to secure the payload 300 relative to the nadir deck 240 of the satellite 202. The mounts 322 can comprise one or more kinematic mounts that effectively isolate the system from spacecraft intra-body torques. Thus, loads or forces associated with launching the satellite 202, which may be exerted on the system 200 and the payload 300, can be passed through the mounts 322. In some embodiments, the mounts 322 can comprise kinematic mounts. Further, the system 200, although illustrated as comprising only mounts 322, can, in some embodiments, comprise more or fewer mounts 322, such as one, two, three, four, five, six, seven, eight, nine, ten or more.

This application includes description that is provided to enable a person of ordinary skill in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. It is understood that the specific order or hierarchy of steps or blocks in the processes disclosed is an illustration of exemplary approaches. Based upon design preferences, it is understood that the specific order or hierarchy of steps or blocks in the processes may be rearranged. The accompanying method claims present elements of the various steps in a sample order, and are not meant to be limited to the specific order or hierarchy presented. Thus, the claims are not intended to be limited to the aspects shown herein, but are to be accorded the full scope consistent with the language of the claims.

Headings and subheadings, if any, are used for convenience only and do not limit the invention.

Reference to an element in the singular is not intended to mean “one and only one” unless specifically so stated, but rather “one or more.” Use of the articles “a” and “an” is to be interpreted as equivalent to the phrase “at least one.” Unless specifically stated otherwise, the terms “a set” and “some” refer to one or more.

Terms such as “top,” “bottom,” “upper,” “lower,” “left,” “right,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Although the relationships among various components are described herein and/or are illustrated as being orthogonal or perpendicular, those components can be arranged in other configurations in some embodiments. For example, the angles formed between the referenced components can be greater or less than 90 degrees in some embodiments.

Although various components are illustrated as being flat and/or straight, those components can have other configurations, such as curved or tapered for example, in some embodiments.

Pronouns in the masculine (e.g., his) include the feminine and neuter gender (e.g., her and its) and vice versa. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “operation for.”

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Although embodiments of the present disclosure have been described and illustrated in detail, it is to be clearly understood that the same is by way of illustration and example only and is not to be taken by way of limitation, the scope of the present invention being limited only by the terms of the appended claims.

What is claimed is:

1. An instrument mounting system for a host satellite, the system comprising:
a mounting panel comprising at least one mount for coupling the mounting panel relative to a base panel of the satellite, the mounting panel being configured to support at least one hosted instrument;
a radiator component extending transversely relative to the mounting panel, the radiator component configured to radiate excess heat from one or more components of the satellite, the radiator component extending along a longitudinal axis of the satellite; and
a heat pipe assembly coupled to the mounting panel and the radiator component, the heat pipe assembly being configured to remove heat from the mounting panel or the radiator component.

2. The system of claim 1, wherein the heat pipe assembly comprises a plurality of heat pipes.

3. The system of claim 1, wherein the heat pipe assembly is at least partially embedded into at least one of the mounting panel or the radiator component.

4. The system of claim 1, wherein the heat pipe assembly comprises at least one flexible component, the flexible component configured to permit the heat pipe assembly to move relative to at least one of the mounting panel or the radiator component to prevent transmission of torque or force between the heat pipe assembly and the mounting panel or radiator component.

5. The system of claim 4, wherein the heat pipe assembly comprises at least one flexible heat pipe.

6. The system of claim 1, wherein the heat pipe assembly extends between the mounting panel and the radiator component in a substantially perpendicular orientation such that the mounting panel and the radiator component are oriented substantially perpendicularly relative to each other.

7. The system of claim 1, wherein the system defines a hosted instrument section defined at least in part by the mounting panel and the radiator component, wherein the hosted instrument section comprises an available volume of at least 0.7 m³ wherein the at least one hosted instrument can be supported.

8. The system of claim 7, wherein the available volume is at least 1 m³.

9. The system of claim 1, wherein the mounting panel comprises a honeycomb structure.

10. A payload mounting system for a host satellite, the system comprising:
a mounting plate configured to be coupled to a base panel of a host satellite, the mounting plate comprising a forward surface configured to support at least one hosted instrument on the surface;
a radiator component coupled to the mounting plate and extending transversely relative to the mounting plate and in a direction away from the base panel, the radiator component comprising a host side portion and a hosted side portion, the hosted side portion being opposite the host side portion and being configured to mount at least one host component on the host side portion and to provide thermal heat rejection for the at least one host component, the hosted side portion of the radiator being free of coupling relative to the at least one hosted instrument;
wherein the radiator component defines a profile, wherein a host component comprises a first field of view extending in a direction away from the host side portion and free of the radiator component profile, and wherein a hosted instrument comprises a second field of view extending in a direction away from the hosted side portion and free of the radiator component profile.

11. The system of claim 10, wherein the radiator component comprises a panel having a tapering width.

12. The system of claim 11, wherein the width decreases in a direction extending away from the forward surface.

13. The system of claim 11, wherein the width tapers progressively to substantially approximate an inner profile of a launch fairing for the satellite.

14. The system of claim 10, wherein the radiator component lies in a plane, and wherein the first and second fields of view extend transversely relative to the plane, the first and second fields of view being uninterrupted by the radiator component.

15. The system of claim 10, wherein the first and second fields of view overlap each other.

16. An instrument mounting system for a host satellite, the system comprising:
a support component having first and second sections,
the first section having a mounting side and a hosted side, the mounting side being attachable to a base panel of a host satellite, the hosted side being opposite the mounting side and being configured to support at least one hosted instrument,
the second section extending transversely relative to the first section and away from the base panel, the second section having a host side and a hosted side, the host side comprising a plurality of mounting positions, the plurality of mounting positions configured such that one or more system components of the satellite can be supported on at least one of the mounting positions, the hosted side being opposite the hosted side and extending along an envelope of the at least one hosted instrument.

17. The system of claim 16, wherein the first section of the support component is configured to radiate excess heat away from the at least one hosted instrument when the at least one hosted instrument is coupled to the first section.

18. The system of claim 16, wherein the second section of the support component is configured to radiate excess heat away from the one or more system components of the satellite when the one or more system components are coupled to the second section.

19. The system of claim 16, wherein the second section extends along a longitudinal axis of the satellite when the second section is coupled to the satellite.

20. The system of claim 16, wherein the first and second sections are interconnected using a flexible coupling.
